(19) United States
(12) Patent Application Publication
(10) Pub. No.: US 2016/0022073 A1
(43) Pub. Date: Jan. 28, 2016

(54) Beverage Container with an Integral Textured Sidewall and Methods of Use

(71) Applicant: Dormini Mangum, Marietta, GA (US)

(72) Inventor: Dormini Mangum, Marietta, GA (US)

(21) Appl. No.: 14/341,954

(22) Filed: Jul. 28, 2014

(51) Int. Cl. A47G 23/02; B29D 22/00; B29C 43/02

(52) U.S. Cl. CPC A47G 23/0216; B29C 43/021; B29D 22/003; B29L 2031/7158

(57) ABSTRACT

A beverage container with an integral textured sidewall formed therein and methods of use, in general, a container having a sidewall, the sidewall formed having an integral small patterned texture formed thereon to prevent condensation slippage.

### TECHNICAL FIELD

The disclosure relates generally to liquid beverage containers or drink receptacle and more specifically it relates to a chilled beverage container.

### BACKGROUND

Various containers such as aluminum cans and plastic bottles are known in the prior art, for example, there are aluminum beer and soda cans, and plastic or glass water, tea, beer and soda bottles available on the market. It is known to configure such deformable containers with indents, ridges, rings and other large deformations in the ends, junctions or sidewalls of such containers to reinforce the containers form and prevent deformation of the container when the container is squeezed or pressurized. It is still further known to configure such containers with recessed finger grooves in the sidewalls of such containers to enable a user to insert their fingers therein to ergonomically grip the container. However, in such chilled containers the sidewall surface area is primarily occupied by a flat smooth surface which is slick or slippery when gripped.

Moreover, many such containers are utilized to provide a beverage such as soda, beer, tea, water and the like and such beverages are preferably served cold or chilled. When cold beverages are served the ambient air is often humid and warmer than the container and beverage temperature resulting in condensation forming on the container adding to the slickness or slippery surface when a user attempts to grip the container.

One previous approach is to add a silicone sleeve to the exterior of the container to prevent a glass container from shattering. Another approach is to add a braided metal mesh sleeve to the exterior of the container for more secure gripping.

Therefore, it is readily apparent that there is a recognizable unmet need for a beverage container with an integral textured sidewall and methods of use, wherein a small pattern textured exterior sidewall provides secure gripping of a wet or condensation covered container.

### BRIEF SUMMARY

Briefly described, in example embodiment, the present apparatus overcomes the above-mentioned disadvantage, and meets the recognized need for a beverage container with an integral textured sidewall formed thereon and methods of use comprising, in general, a container having a sidewall, the sidewall formed having an integral small or tight dimensioned texture pattern repeated or duplicated or formed therein, and, thus, such container functions to provide secure gripping of a wet or condensation covered sidewall container.

According to its major aspects and broadly stated, the beverage container with an integral textured sidewall and methods of use comprising, in general a container having a bottom base portion, and an upper sidewall, wherein the sidewall is formed having an integral small or tight dimensioned texture pattern repeated or duplicated or formed therein or thereon.

In an exemplary embodiment of the beverage container with integral textured sidewall includes a container, the container having a bottom base and a sidewall, the sidewall formed having a texture integral with said sidewall, wherein said texture is configured from a small repeated pattern.

In a further exemplary embodiment of the method of forming a beverage container, including the steps of providing a container, the container having a bottom base and a sidewall, pressing a texture therein the sidewall, wherein said texture is configured from a small repeated pattern.

In a further exemplary embodiment of the method of forming a beverage container, including the steps of providing a container, the container having a bottom base and a sidewall, rolling a texture therein the sidewall, wherein said texture is configured from a small repeated pattern.

Accordingly, a feature of the beverage container with an integral textured sidewall and methods of use is its ability to provide a beverage container with an integral textured sidewall exterior surface configured to prevent slippage due to a smooth sidewall surface of an ordinary beverage container having a wet or condensation covered sidewall container.

Another feature of the beverage container with an integral textured sidewall and methods of use is its ability to provide a stamped, rolled, molded, or pressed small or tight dimensioned texture pattern repeated or duplicated or formed during the beverage container assembly or manufacture.

Still another feature of the beverage container with an integral textured sidewall and methods of use is its ability to provide small repeated indentation or indent portion in the sidewall of the container to achieve a texture capable of resisting dew and condensation slippage when gripping a beverage container.

Yet another feature of the beverage container with an integral textured sidewall and methods of use is its ability to provide small repeated bump, protrusion, or raised portion in the sidewall of the container to achieve a texture capable of resisting dew and condensation slippage when gripping a beverage container.

Yet another feature the beverage container with an integral textured sidewall and methods of use is its ability to provide small repeated etch or scratch portion in the sidewall of the container to achieve a texture capable of resisting dew and condensation slippage when gripping a beverage container.

Yet another feature of the beverage container with an integral textured sidewall and methods of use is its ability to provide a variety of patterns of texture to achieve a texture capable of resisting dew and condensation slippage when gripping a beverage container.

Yet another feature of the beverage container with an integral textured sidewall and methods of use is its ability to provide a variety of tight or small repeatable patterns of texture to achieve a texture capable of resisting dew and condensation slippage when gripping a beverage container.

Yet another feature of the beverage container with an integral textured sidewall and methods of use is its ability to be processed by existing beverage container processing equipment, such as washers, dryers, rollers, rotation printing systems, varnish applicators, ovens, conveyors, sprayers, necker, flanger, filler, or pull tab cover attachment machines, collectively a standard container process.

Yet another feature of the beverage container with an integral textured sidewall and methods of use is its ability to provide a texture configured as any repeating small pattern and yet still provide a surface to sidewall, which feels comfortable against the bottom lip when drinking from beverage container.

Yet another feature of the beverage container with an integral textured sidewall and methods of use is its ability to provide a texture to beverage containers, especially when the ambient air is often humid and warmer than the container and beverage temperature resulting in condensation forming on the container adding to the slickness or slippery surface when a user attempts to grip the container.

Yet another feature of the beverage container with an integral textured sidewall and methods of use is its ability to provide improved elements and arrangements thereof in a container for the purposes described which is inexpensive, dependable and fully effective in accomplishing its intended purposes.

These and other features of the beverage container with an integral textured sidewall and methods of use will become more apparent to one skilled in the art from the following Detailed Description of the Embodiments and Claims when read in light of the accompanying drawing Figures.

### BRIEF DESCRIPTION OF THE DRAWINGS

The present beverage container with an integral textured sidewall and methods of use will be better understood by reading the Detailed Description of the embodiments with reference to the accompanying drawing figures, in which like reference numerals denote similar structure and refer to like elements throughout, and in which:

FIG. 1 is a front perspective view of a beverage container;

FIG. 2 a cross section view of beverage container of FIG. 1 being formed with an integral texture to the sidewall;

FIG. 3 is a front side perspective view of an example embodiment beverage container configured with an integral textured sidewall;

FIG. 4 is a front side perspective view of an example embodiment beverage container configured with an alternate integral textured sidewall;

FIG. 5 is a front side perspective view of an example embodiment beverage container configured with another alternate integral textured sidewall;

FIG. 6 is an front side perspective view of an example embodiment beverage container configured with another alternate integral textured sidewall, shown being gripped; and

FIG. 7 is a flow diagram of a method of gripping a beverage container configured with an integral textured sidewall.

It is to be noted that the drawings presented are intended solely for the purpose of illustration and that they are, therefore, neither desired nor intended to limit the disclosure to any or all of the exact details of construction shown, except insofar as they may be deemed essential to the claimed invention.

### DETAILED DESCRIPTION

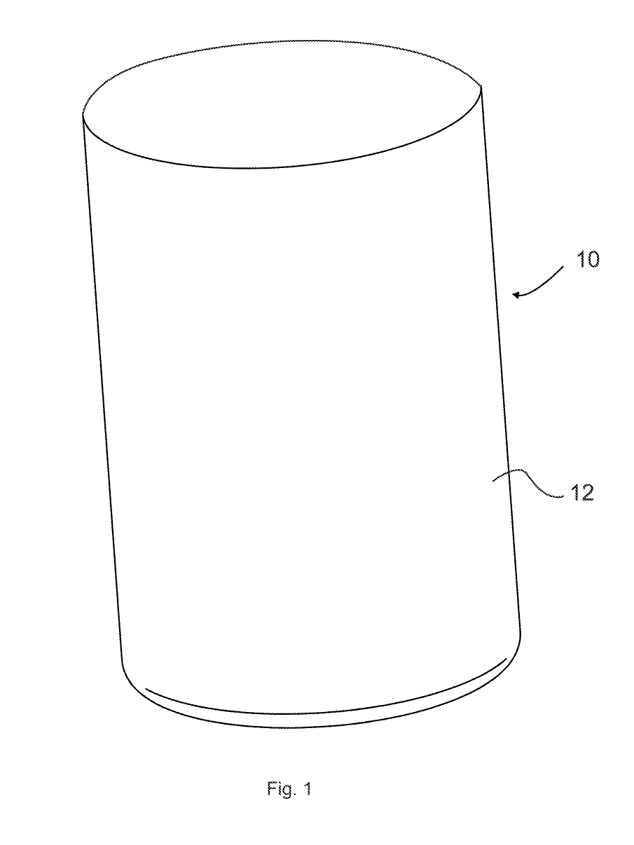

In describing the exemplary embodiments of the present disclosure, as illustrated in FIGS. 1-7 specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

Referring now to FIG. 1, by way of example, and not limitation, there is illustrated a front perspective view of a container, plastic bottle, beverage apparatus, or metal can, such as standard beverage container 10.

Preferably beverage container 10 may be formed by punching out a circular disc approximately 5½ inches in diameter from a sheet of aluminum. Next the circular disc is bent into a cup configuration. To extend the sidewalls of the cup into a can body the cup is fed into a draw and iron body maker to draw out the sidewall into a narrow cylindrical can configuration, shown in FIG. 1 as beverage container 10. Next a trimmer cleans and straightens the top edge of beverage container 10. Preferably beverage container 10 includes bottom 26, sidewall 12, a neck, such as rim 24 and a lid, such as top 22.

It is recognized herein that texturizing may take place after the aluminum coil is cut into circular disc, formed into a cup, or after drawn out into a can body configuration. It is further recognized herein that texturizing may take place at various junctures of beverage container 10 formation process including but not limited to, the cupper phase, the body maker phase, or the draw/redraw phase.

Beverage container 10 is preferably formed of a suitable material, such as aluminum, steel, rigid plastic or flexible plastic, metal, tin, alloy, stainless steel, or the like, capable of providing structure to beverage container 10. Preferably, the material includes other suitable characteristics, such as durability, rust-resistance, light weight, ability to hold a beverage or beverage under pressure, heat-resistance, chemical inertness, oxidation resistance, ease of workability, or other beneficial characteristic understood by one skilled in the art.

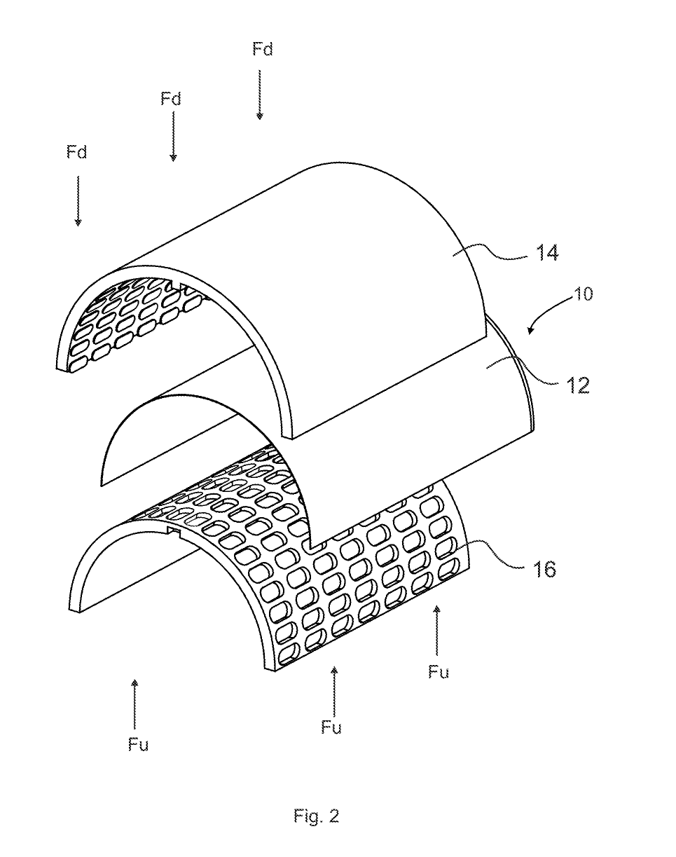

Referring now to FIG. 2, by way of example, and not limitation, there is illustrated a half cross section view of beverage container 10 of FIG. 1 shown positioned between inner mold plate 16 and outer mold plate 14. It is contemplated herein that either inner mold plate 16 or outer mold plate 14 may include protrusion 18 or indentation 19 therein to form, stamp, shape or impart thereon texture 28 integral to the sidewall 12 when pressed therebetween inner mold plate 16 or outer mold plate 14 via pressing force Fd and pressing force Fu.

It is recognized herein that alternate methods are known to one having ordinary skill in the art to form or impart texture 28 integral to sidewall 12. For example, if beverage container 10 is to be made of a plastic material then texture 28 may be integral to a plastic bottle mold similar to inner mold plate 16 or outer mold plate 14 to form texture 28 therein sidewall 12 of plastic beverage container 10. An alternative example may be to roll sidewall 12 of beverage container 10, via a flat surface roller 16, represented by inner mold plate 16, across a mold plate, such as outer mold plate 14 to texture, form or impart therein an integral texture 28 to sidewall 12. Still another alternative example may be to repeatedly punch sidewall 12 of beverage container 10 with a small die configured with a repeatable small or tight textured pattern.

It is contemplated herein that texture 28 may be formed or imparted thereon sidewall 12 to provide a secure gripping area therein or thereon sidewall 12.

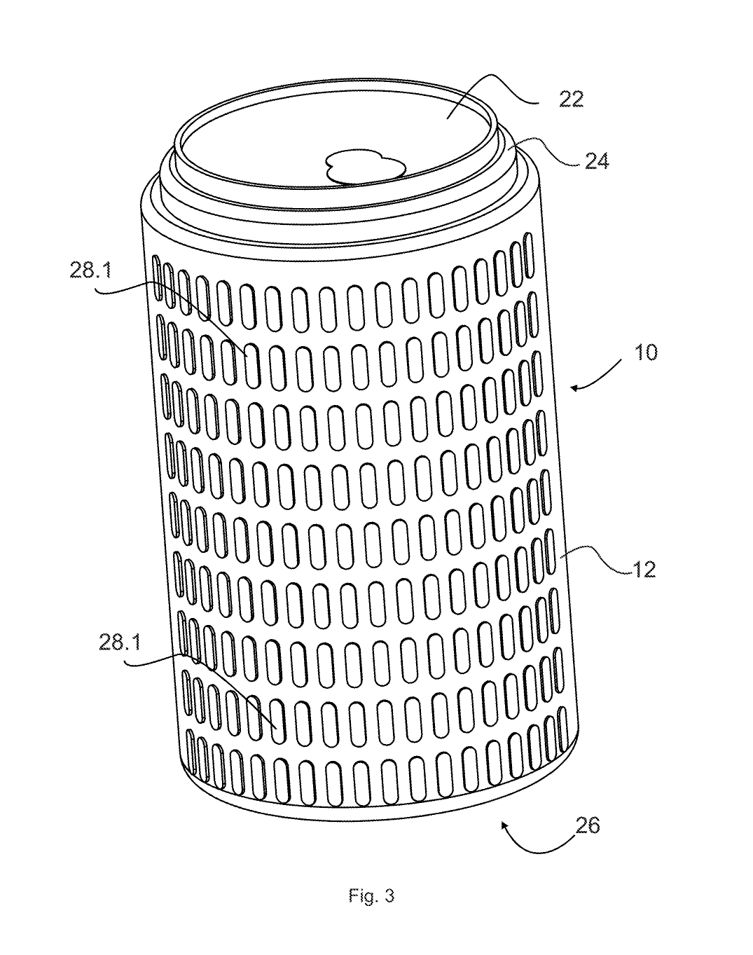

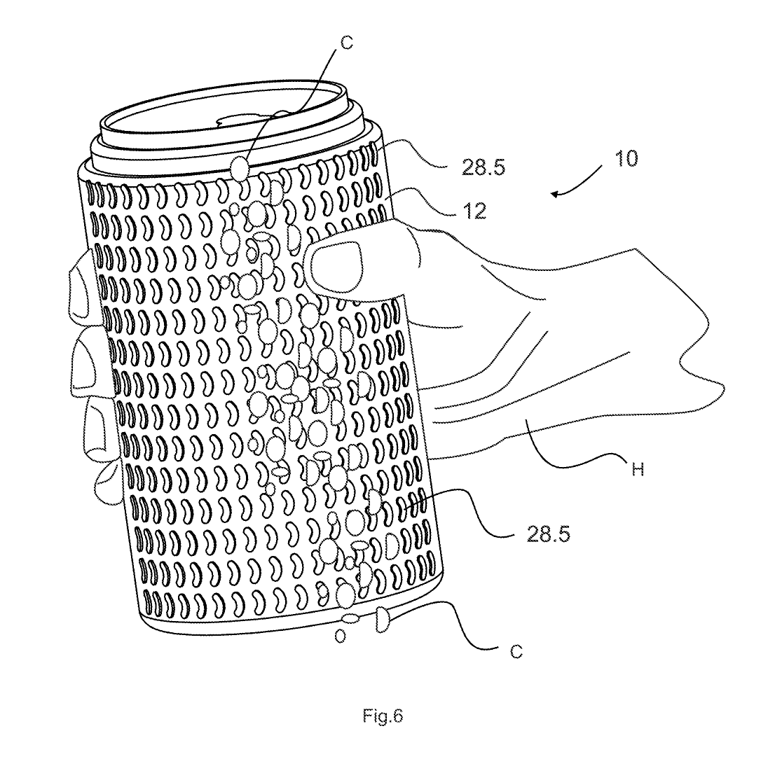

Referring now to FIGS. 3-5, by way of example, and not limitation, there is illustrated a set of finished beverage container 10 preferably configured having various small or tight dimensioned texture pattern repeated or duplicated or formed, such as texture 28, therein sidewall 12 or thereon the outer surface of sidewall 12 formed integral to or therein or repeated thereon sidewall 12. It is recognized herein that texture 28 may be a small repeated pattern, repeated indentation, repeated protrusion, or repeated etch positioned on an exterior surface of sidewall 12 and either cover sidewall 12, cover a portion or partially cover sidewall 12, be in the shape of fingers or configured as hand shaped on sidewall 12, hand H as shown in FIG. 6, or be configured in any other shape on sidewall 12. Moreover, texture 28 is preferably a tight or small pattern texture, such as texture 28 formed integral to or repeated therein sidewall 12, and, thus, such textured container, such as beverage container 10 configured with texture 28 functions to provide a secure gripping area to sidewall 12 when sidewall 12 is wet or condensation forms thereon sidewall 12. It is recognized herein that texture 28 may be configured as repeating/repeated small or tight pattern of protrusion and/or indentation, etch or other shape to form a tactile characteristic to the outer surface of sidewall 12.

Moreover, when texture 28 is formed therein sidewall 12 beverage container 10, this enables beverage container to be processed by existing beverage container processing equipment, such as washers, dryers, rollers, rotation printing systems, varnish applicators, ovens, conveyors, sprayers, necker, flanger, filler, and pull tab cover attachment machines.

Referring again now to FIG. 3, by way of example, and not limitation, there is illustrated beverage container 10 preferably configured having texture 28.1 formed therein sidewall 12 of beverage container 10. Preferably texture 28.1 may be configured as repeating/repeated small or tight pattern of raised ovals.

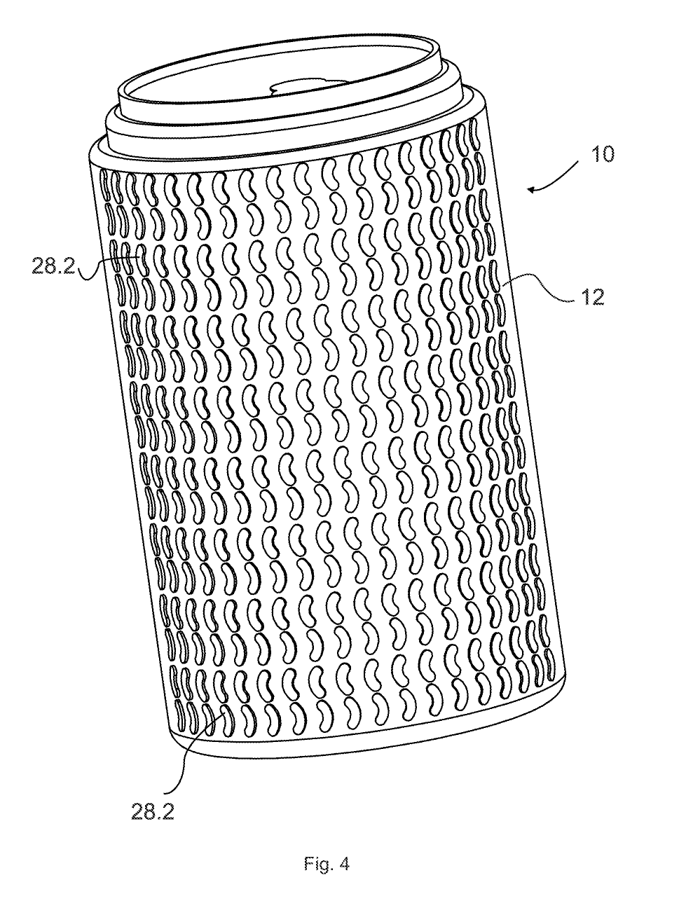

Referring again now to FIG. 4, by way of example, and not limitation, there is illustrated beverage container 10 preferably configured having small patterned textures, such as texture 28.2 formed therein sidewall 12 of beverage container 10. Preferably texture 28.2 may be configured as repeating/repeated small or tight pattern of raised arced or bent ovals.

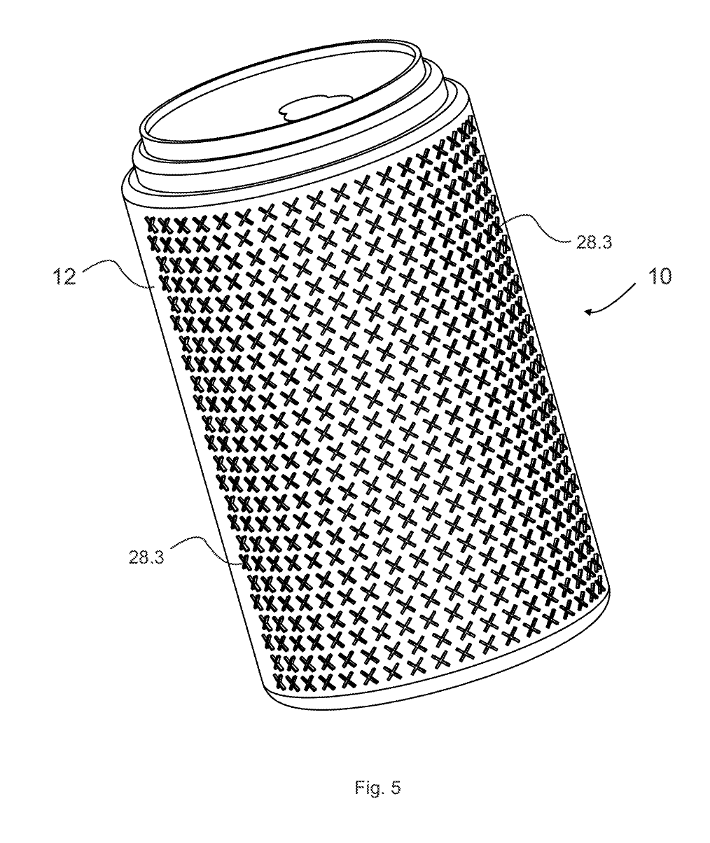

Referring again now to FIG. 5, by way of example, and not limitation, there is illustrated beverage container 10 preferably configured having small pattern textures, such as texture 28.3 formed therein sidewall 12 of beverage container 10. Preferably texture 28.3 may be configured as repeating/repeated small or tight pattern of raised etches. It is recognized herein that configurations such as ‘X’ or ‘I’ or woven pattern ‘#’, or herringbone, or honeycomb, or other shaped repeated or duplicated protrusions and/or indentations as small or tight pattern may be utilized.

It is contemplated herein that texture 28 may be configured as any repeating small or tight pattern whether formed, stamped, shaped, imparted, etched, indented, or as a raised or protrusion configuration and texture 28 may comprise any pattern or shape contemplated by one of ordinary skill in the art.

It is further contemplated herein that texture 28 may be configured as any repeating small or tight pattern and yet still provide a smooth surface to sidewall 12 which feels comfortable against the bottom lip when drinking from beverage container 10.

It is further contemplated herein that texture 28 may be configured as any repeating small or tight textured pattern and yet still provide a smooth surface to sidewall 12 to enable can processing by existing beverage container processing equipment, such as washers, dryers, rollers, rotation printing systems, varnish applicators, ovens, conveyors, sprayers, necker, flanger, filler, and pull tab cover attachment machines.

Referring now to FIG. 6, by way of example, and not limitation, there is illustrated beverage container 10 shown in use. In use, beverage container 10 may be pulled from an icy water bath such as a cooler or the chilled beverage container 10 may be in use in a hot and humid climate wherein condensation or dew forms on the cold exterior surface sidewall 12. In these conditions of a wet or condensation C covered sidewall 12 standard beverage container 10, shown in FIG. 1, having a smooth sidewall 12 may slip from the grip of a user. Alternatively, as disclosed herein, beverage container 10 preferably configured having various small or tight dimensioned texture pattern repeated or duplicated or formed therein, such as texture 28 formed integral to sidewall 12 to resist dew and condensation C slippage when hand H grips beverage container 10.

Referring again to FIG. 6, there is illustrated a method for gripping beverage container 10. First, providing beverage container 10 preferably configured having various small or tight dimensioned textured pattern repeated or duplicated or formed therein, such as texture 28, as shown in FIGS. 3-5. Next, gripping with hand H (via a user's hand H grips) sidewall 12 of beverage container 10. Next, resisting slippage between hand H and sidewall 12 of beverage container 10 due to dew and condensation C formed thereon chilled beverage container 10.

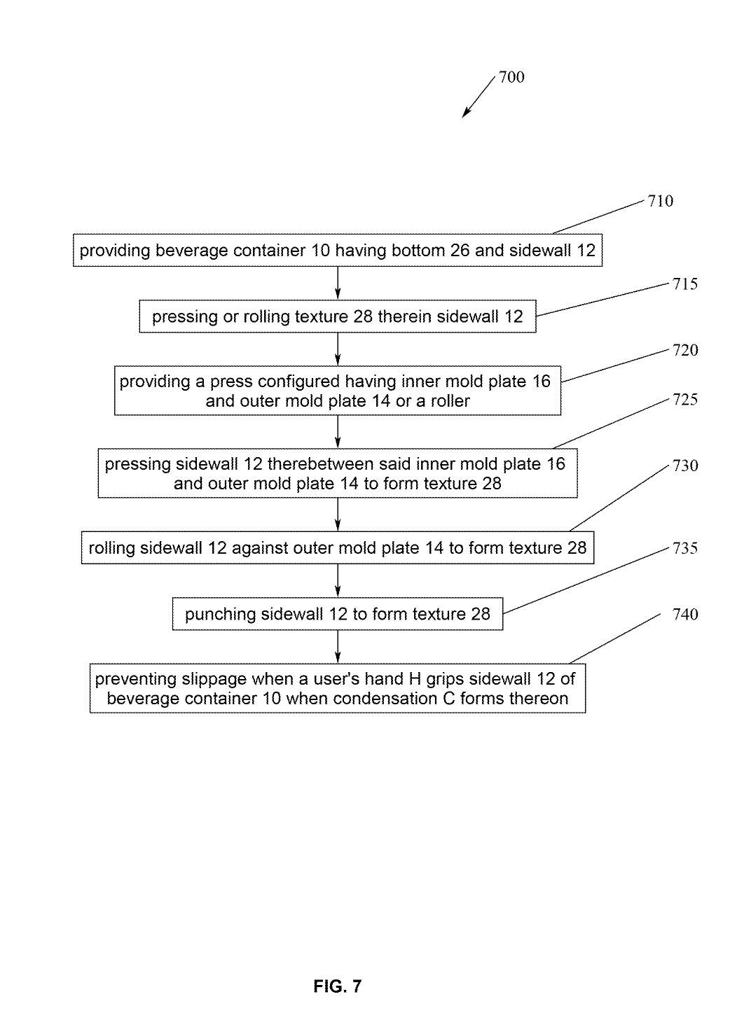

Referring now to FIG. 7, by way of example, and not limitation, there is illustrated a flow diagram 700 of a method of making beverage container 10. In block or step 710, providing beverage container 10 having bottom 26, sidewall 12, a neck, such as rim 24 and a lid, such as top as described above in FIG. 1. In block or step 715 pressing or rolling small or tight dimensioned texture pattern repeated or duplicated or formed, such as texture 28, therein sidewall 12. In block or step 720, further providing press shown in FIG. 2 or press configured having inner mold plate 16 and outer mold plate 14 or a roller shown in FIG. 2. In block or step 725, pressing said sidewall 12 therebetween said inner mold plate 16 and outer mold plate 14 to form texture 28. In block or step 730, rolling sidewall 12 against outer mold plate 14 to form texture 28 thereon sidewall 12 of beverage container 10. In block or step 735, punching sidewall 12 to form texture 28 thereon sidewall 12 of beverage container 10. In block or step 740, preventing slippage of user's hand H along sidewall 12 due to tactile characteristic of texture 28 when user's hand H grips sidewall 12 due to condensation C forming on sidewall 12 of beverage container 10.

The foregoing description and drawings comprise illustrative embodiments of the present disclosure. Having thus described exemplary embodiments, it should be noted by those ordinarily skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one ordinarily skilled in the art to which this invention pertains having the benefit of the teachings presented in the foregoing descriptions and the associated drawings. Although specific terms may be employed herein, they are used in a generic and descriptive sense only and not for purposes of limitation. Moreover, the present invention has been described in detail; it should be understood that various changes, substitutions and alterations can be made thereto without departing from the spirit and scope of the invention as defined by the appended claims. Accordingly, the present invention is not limited to the specific embodiments illustrated herein, but is limited only by the following claims.

What is claimed is:

1. A beverage apparatus, comprising:
a container, said container having a bottom base and a sidewall, said sidewall formed having a texture integral with said sidewall, wherein said texture is configured from a small repeated pattern.

2. The apparatus of claim 1, wherein said texture is configured to prevent slippage when a condensation forms on said sidewall.

3. The apparatus of claim 1, wherein said texture is configured as a repeated indentation.

4. The apparatus of claim 1, wherein said texture is configured as a repeated protrusion.

5. The apparatus of claim 1, wherein said texture is configured as a repeated indentation and a repeated protrusion.

6. The apparatus of claim 1, wherein said texture is configured as a repeated etch.

7. The apparatus of claim 1, wherein said texture is configured to enable use in a standard container process.

8. The apparatus of claim 1, wherein said texture is configured to cover said sidewall.

9. The apparatus of claim 1, wherein said texture is configured to cover a portion of said sidewall.

10. The apparatus of claim 9, wherein said portion is configured as a hand shape.

11. The apparatus of claim 1, wherein said texture is configured to provide a secure gripping area thereon said sidewall.

12. A method of forming a beverage container comprising steps of:
providing a container, said container having a bottom base and a sidewall;
pressing a texture therein said sidewall, wherein said texture is configured from a small repeated pattern.

13. The method of claim 12, further comprising the step of providing a press configured having an inner mold plate and an outer mold plate.

14. The method of claim 13, further comprising the step of pressing said sidewall therebetween said inner mold plate and said outer mold plate to form said texture.

15. The method of claim 12, further comprising the step of preventing a slippage when a user's hand grips said sidewall of said container.

16. The method of claim 12, further comprising the step of providing an outer mold plate.

17. The method of claim 13, further comprising the step of pressing said sidewall against said outer mold plate to form said texture.

18. A method of forming a beverage container comprising the steps of:
providing a container, said container having a bottom base and a sidewall;
rolling a texture therein said sidewall, wherein said texture is configured from a small repeated pattern.

19. The method of claim 18, further comprising the step of providing a roller and an outer mold plate.

20. The method of claim 19, further comprising the step of rolling said sidewall against said outer mold plate to form said texture.

21. The method of claim 18, further comprising the step of preventing a slippage when a user's hand grips said sidewall of said container.
